(19) United States
(12) Patent Application Publication
(10) Pub. No.: US 2023/0307754 A1
(43) Pub. Date: Sep. 28, 2023

(54) ENERGY STORAGE RACK

(71) Applicant: CALB Co., Ltd., Jiangsu (CN)

(72) Inventors: Wei Li, Luoyang (CN); Tengteng Shi, Luoyang (CN); Fei Li, Luoyang (CN)

(73) Assignee: CALB Co., Ltd., Jiangsu (CN)

(21) Appl. No.: 17/834,903

(22) Filed: Jun. 7, 2022

(30) Foreign Application Priority Data
Mar. 25, 2022 (CN) 202210298977.0

(51) Int. Cl. H01M 50/204

(52) U.S. Cl. CPC H01M 50/204

(57) ABSTRACT

An energy storage rack includes a vertical column and a horizontal beam. The vertical column is formed by a first beam and a second beam butting against each other. The first beam includes a first main body and first connecting plates, and the first main body has a first groove. The second beam includes a second main body and second connecting plates, and the second main body has a second groove. The two second connecting plates are correspondingly connected to the two first connecting plates, and the first groove communicates with the second groove to form a hollow cavity. The first beam is fixedly connected to the second beam through the first connecting plates and the second connecting plates.

### CROSS-REFERENCE TO RELATED APPLICATION

This application claims the priority benefit of China application no. 202210298977.0, filed on Mar. 25, 2022. The entirety of the above-mentioned patent application is hereby incorporated by reference herein and made a part of this specification.

### BACKGROUND

### Technical Field

The disclosure relates to the field of battery technology, and in particular, relates to an energy storage rack.

### Description of Related Art

In the design of the energy storage rack, the bearing capacity and stability of the energy storage rack are important. At present, the energy storage rack is generally composed of vertical columns and horizontal beams. The vertical columns are configured as the main support members since the vertical columns are required to support the weight of the entire battery cluster. However, the vertical columns provided by the related art exhibit insufficient overall strength, and as a result, the energy storage rack provides only low overall strength and exhibits limited bearing capacity and poor stability.

### SUMMARY

The disclosure aims to provide an energy storage rack.

The energy storage rack includes a vertical column and a horizontal beam connected to each other. The vertical column is a hollow column structure formed by a first beam and a second beam butting against each other. The first beam includes a first main body and first connecting plates, the first main body has a first groove, and two sides of the first main body are respectively connected to the first connecting plates. The first connecting plates are located at an opening of the first main body. The second beam includes a second main body and second connecting plates, the second main body has a second groove, and two sides of the second main body are respectively connected to the second connecting plates. The second connecting plates are located at an opening of the second main body. The two second connecting plates are correspondingly connected to the two first connecting plates, and the first groove communicates with the second groove to form a hollow cavity.

### BRIEF DESCRIPTION OF THE DRAWINGS

For a better understanding of the disclosure, reference may be made to exemplary embodiments shown in the following drawings. The components in the drawings are not necessarily to scale and related elements may be omitted, or in some instances proportions may have been exaggerated, so as to emphasize and clearly illustrate the features described herein. In addition, related elements or components can be variously arranged, as known in the art. Further, in the drawings, like reference numerals designate same or like parts throughout the several views.

FIG. 1 is a schematic view of an energy storage rack according to the disclosure.

FIG. 2 is a schematic view of a part of the energy storage rack shown in FIG. 1.

FIG. 2a is a partial cross-sectional view of the structure shown in FIG. 2 according to embodiment one.

FIG. 2b is a partial cross-sectional view of the structure shown in FIG. 2 according to embodiment two.

FIG. 3 is an enlarged schematic view of portion A in FIG. 2.

FIG. 4 is an enlarged schematic view of portion B in FIG. 2.

FIG. 5 is a schematic view of a part of the energy storage rack according to an embodiment of the disclosure.

FIG. 6 is a schematic view of a vertical column according to embodiment one of the disclosure.

FIG. 7 is a schematic view of the vertical column according to embodiment two of the disclosure.

FIG. 8 is a schematic view of the energy storage rack matched with battery insertion boxes according to the disclosure.

### DESCRIPTION OF THE EMBODIMENTS

The technical solutions in the exemplary embodiments of the disclosure will be described clearly and explicitly in conjunction with the drawings in the exemplary embodiments of the disclosure. The description proposed herein is just the exemplary embodiments for the purpose of illustrations only, not intended to limit the scope of the disclosure, so it should be understood that and various modifications and variations could be made thereto without departing from the scope of the disclosure.

In the description of the present disclosure, unless otherwise specifically defined and limited, the terms “first”, “second” and the like are only used for illustrative purposes and are not to be construed as expressing or implying a relative importance. The term “plurality” is two or more. The term “and/or” includes any and all combinations of one or more of the associated listed items.

In particular, a reference to “the” object or “a” and “an” object is intended to denote also one of a possible plurality of such objects. Unless otherwise defined or described, the terms “connect”, “fix” should be broadly interpreted, for example, the term “connect” can be “fixedly connect”, “detachably connect”, “integrally connect”, “electrically connect” or “signal connect”. The term “connect” also can be “directly connect” or “indirectly connect via a medium”. For the persons skilled in the art, the specific meanings of the abovementioned terms in the present disclosure can be understood according to the specific situation.

Further, in the description of the present disclosure, it should be understood that spatially relative terms, such as “above”, “below” “inside”, “outside” and the like, are described based on orientations illustrated in the figures, but are not intended to limit the exemplary embodiments of the present disclosure.

In the context, it should also be understood that when an element or features is provided “outside” or “inside” of another element(s), it can be directly provided “outside” or “inside” of the other element, or be indirectly provided “outside” or “inside” of the another element(s) by an intermediate element.

In addition, the technical features involved in the different embodiments of the disclosure described below can be combined with each other as long as the technical features do not conflict with each other. The following discussion provides various embodiments of the disclosure. Although each embodiment represents a single combination of the application, the various embodiments of the disclosure may be substituted or combined. The disclosure is therefore also to be considered to encompass all possible combinations of the same and/or different embodiments recited. If one embodiment includes A, B, C and another embodiment includes a combination of B and D, then the disclosure shall also be considered to include an embodiment including one or more of all other possible combinations of A, B, C, and D, even though this embodiment may not be explicitly described in the text below. In addition, the technical features involved in the different embodiments of the disclosure described below can be combined with each other as long as the technical features do not conflict with each other.

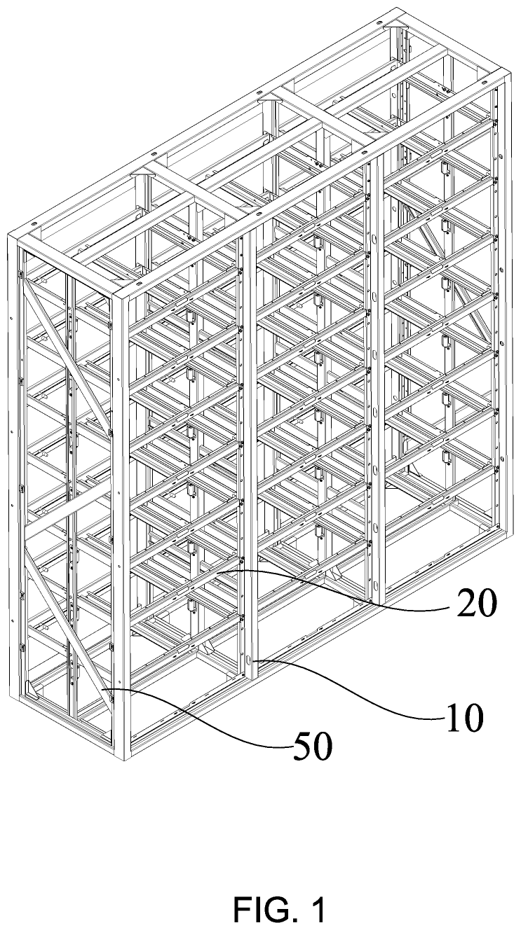

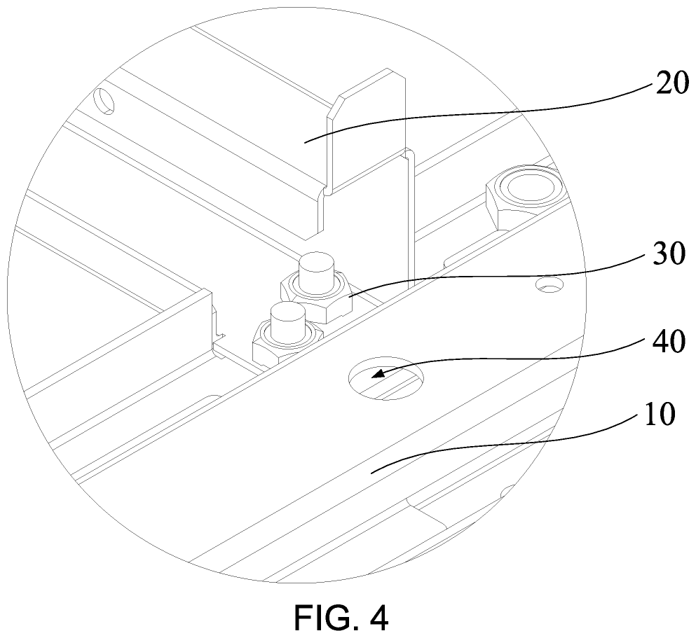

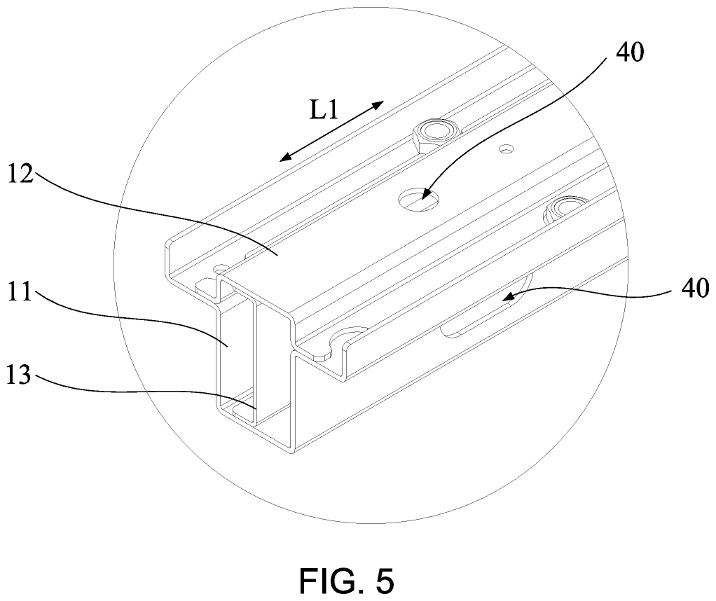

As shown in FIG. 1 to FIG. 7, an energy storage rack provided by the disclosure includes vertical columns 10 and horizontal beams 20 connected to each other. Specifically, the horizontal beams 20 are connected to first connecting plates 112. In a specific embodiment of the disclosure, a plurality of vertical columns 10 are arranged in a vertical direction, and a plurality of horizontal beams 20 are arranged in a horizontal direction. The vertical columns 10 and the horizontal beams 20 are connected horizontally and vertically to form the energy storage rack. To be specific, two ends of each horizontal beam 20 are respectively connected to two vertical columns 10, the vertical columns 10 are perpendicular to the horizontal beams 20, and the vertical columns 10 and the horizontal beams 20 enclose accommodating cavities for accommodating battery insertion boxes. In a preferred embodiment of the disclosure, the energy storage rack further includes inclined beams 50. Two ends of each inclined beam 50 are respectively connected to two vertical columns 10, and the inclined beams 50 are inclined with respect to the vertical columns 10. The arrangement of the inclined beams 50 increases the overall strength of the energy storage rack.

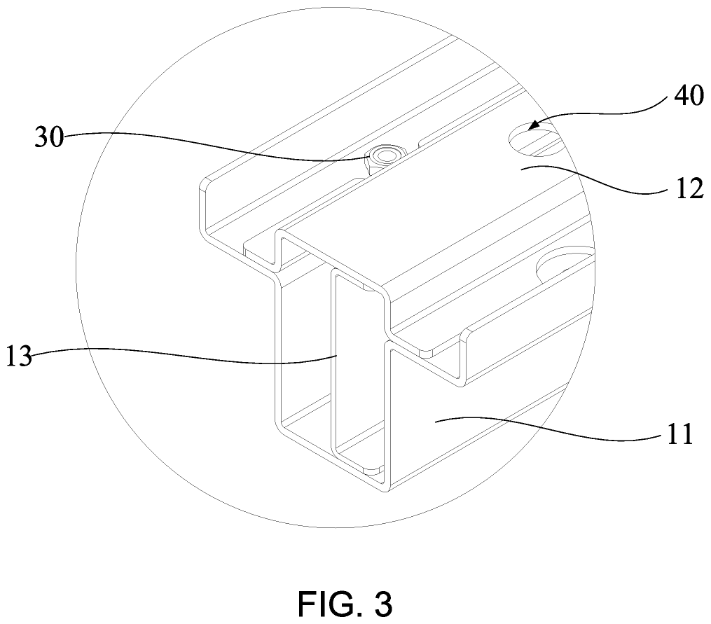

As shown in FIG. 3 and FIG. 6 to FIG. 7, the vertical column 10 is a hollow column structure form by a first beam 11 and a second beam 12 butting against each other.

The first beam 11 includes a first main body 111 and the first connecting plates 112, the first main body 111 has a first groove 113, and two sides of the first main body 111 are respectively connected to the first connecting plates 112. To be specific, the two first connecting plates 112 are symmetrically arranged on both sides of the first main body 111 and are located at an opening of the first groove 113. The first connecting plates 112 are respectively connected to end portions of the first main body 111, so that the first beam 11 as a whole has substantially a “ [symbol] ” shape, wherein the shape of “ [symbol] ” is similar to “π”.

The second beam 12 includes a second main body 121 and second connecting plates 122, the second main body 121 has a second groove 123, and two sides of the second main body 121 are respectively connected to the second connecting plates 122. The two second connecting plates 122 are correspondingly connected to the two first connecting plates 112, the first groove 113 communicates with the second groove 123 to form a hollow cavity, and the hollow cavity is the hollow part of the hollow column structure. In directions in which the first connecting plates 112 are away from the first main body 111, a length of each second connecting plate 122 is less than a length of each first connecting plate 112. To be specific, the two second connecting plates 122 are symmetrically arranged on both sides of the second main body 121 and are located at an opening of the second groove 123. The second connecting plates 122 are respectively connected to end portions of the second main body 121, so that the second beam 12 as a whole has substantially a “ [symbol] ” shape, wherein the shape of “ [symbol] ” is similar to “π”.

In the energy storage rack provided by the disclosure, the first beam 11 is fixedly connected to the second beam 12 through the first connecting plates 112 and the second connecting plates 122. This connection manner is simple and may be conveniently implemented, such that the assembly efficiency of the vertical column is improved. Further, since a larger connection area is provided between the first beam 11 and the second beam 12, the connection strength between the first beam 11 and the second beam 12, the mechanical strength of the vertical column 10 formed by the first beam 11 and the second beam 12, as well as the overall strength of the energy storage rack are all ensured.

Further, as the first groove 113 communicates with the second groove 123 to form a cavity in the middle of the vertical column 10, on the one hand, the overall weight of the vertical column 10 is effectively reduced in a condition that the overall strength of the vertical column 10 is ensured. On the other hand, the first beam 11 and the second beam 12 are made to have a multi-folded structure, which is beneficial to the mechanical strength of the first beam 11 and the second beam 12, such that the vertical column 10 may not be easily broken, may not be easily deformed, and exhibits good reliability in use. Therefore, the overall reliability in use of the energy storage rack is improved, the probability of damage to the energy storage rack is reduced, the service life of the product is prolonged, and the market competitiveness of the product is increased. The multi-folded structure refers to a folded structure with three, four, or more folds.

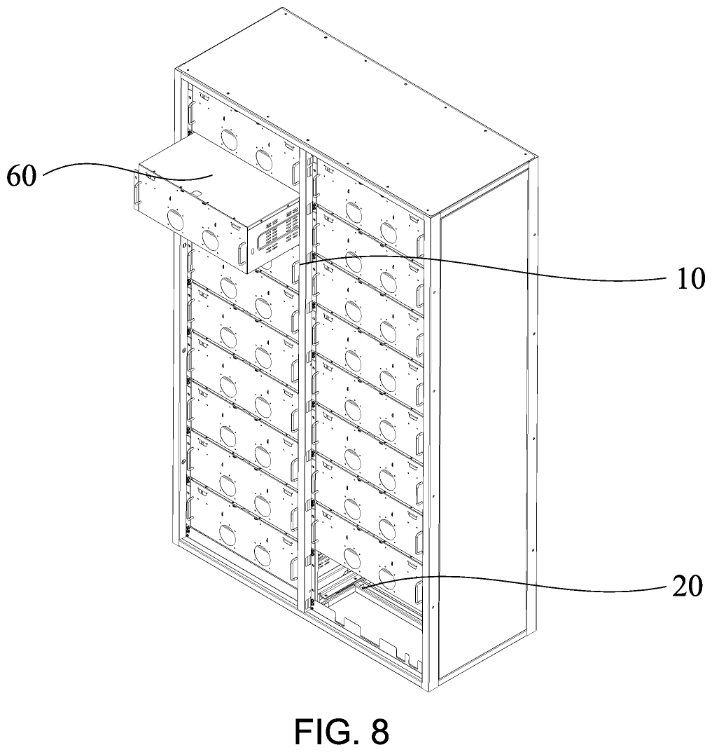

As shown in FIG. 3 and FIG. 6 to FIG. 8, in an embodiment of the disclosure, one end of each first connecting plate 112 away from the first main body 111 is provided with a reinforcement folded edge 14. To be specific, the reinforcement folded edge 14 is perpendicular to the first connecting plate 112.

Through the arrangement of the reinforcement folded edge 14, the number of folded edges of the first beam 11 is increased, such that the first beam 11 has more folded edge structures, and the mechanical strength of the first beam 11 is further improved. As such, the vertical column 10 formed by the first beam 11 may not be easily broken, may not be easily deformed, and exhibits good reliability in use. Therefore, the overall reliability in use of the energy storage rack is improved, the probability of damage to the energy storage rack is reduced, the service life of the product is prolonged, and the market competitiveness of the product is increased. Besides, through the arrangement of the reinforcement folded edge 14, the part of the vertical column 10 in contact with the battery insertion box 60 has no sharp corners. Therefore, the vertical column 10 is prevented from scratching the battery insertion box 60, and the reliability in use of the battery insertion box is thus ensured.

In another specific embodiment of the disclosure, one end of the first connecting plate away from the first main body is bent towards the surface of the first connecting plate to form a folded edge. The plate surface of the folded edge is attached to the plate surface of the first connecting plate, and the folded edge is parallel to the first connecting plate. Through the arrangement of the folded edge, the part of the vertical column in contact with the battery insertion box has no sharp corners. Therefore, the vertical column is prevented from scratching the battery insertion box, and the reliability in use of the battery insertion box is thus ensured.

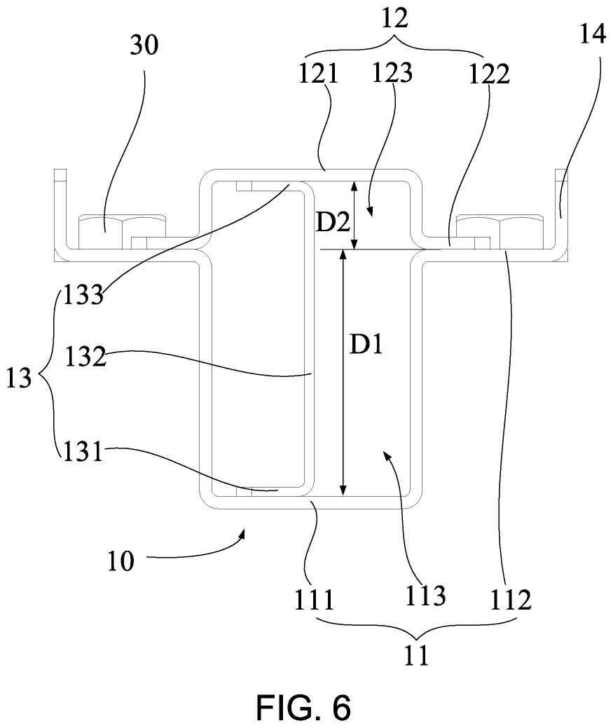

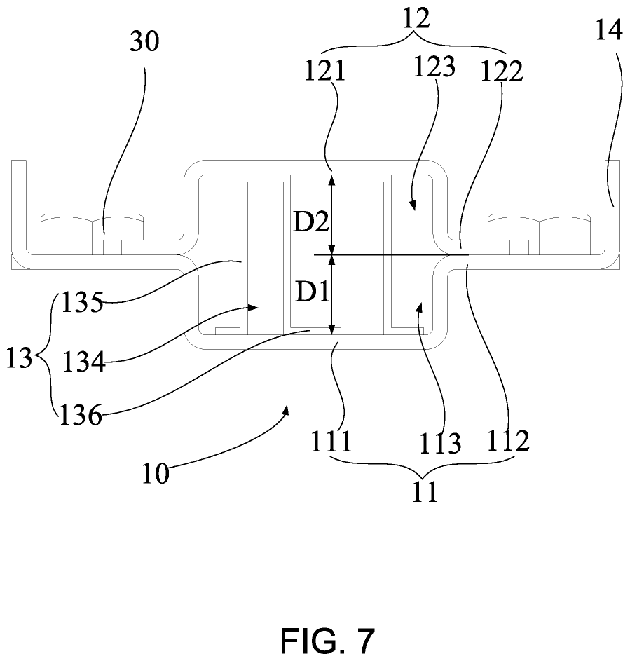

As shown in FIG. 3, FIG. 6, and FIG. 7, in an embodiment of the disclosure, the first beam 11 is a beam formed by bending a sheet metal piece, and/or the second beam 12 is a beam formed by bending a sheet metal piece. That is, each of the first beam 11 and the second beam 12 is an integral structure made by an integral molding process.

The manufacturing process of bending and forming is simple, processing and manufacturing may be conveniently performed, and favorable production efficiency is provided, so that the manufacturing costs of the first beam 11 and the second beam 12 may be lowered, and the market competitiveness of the product is increased. Further, both the first beam 11 and the second beam 12 are integral structures, so the overall strength of the first beam 11 and the second beam 12 is ensured, and that the overall strength of the vertical column 10 formed by the first beam 11 and the second beam 12 is ensured. As such, the vertical column 10 may not be easily broken, may not be easily deformed, and exhibits good reliability in use, such that the reliability in use of the energy storage rack as a whole is improved.

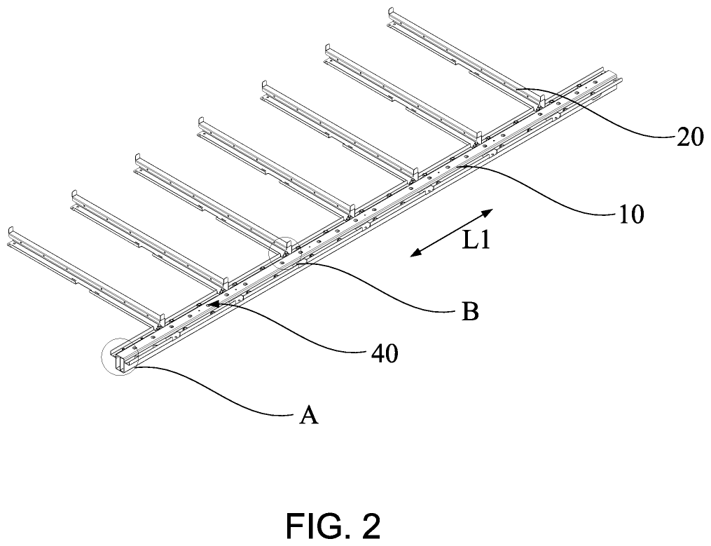

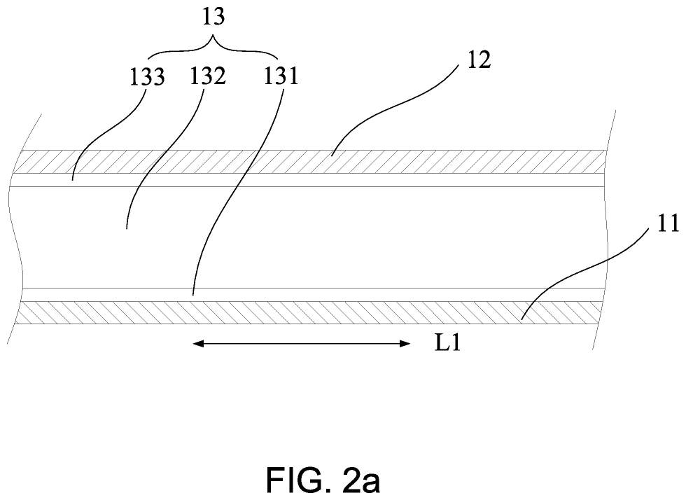

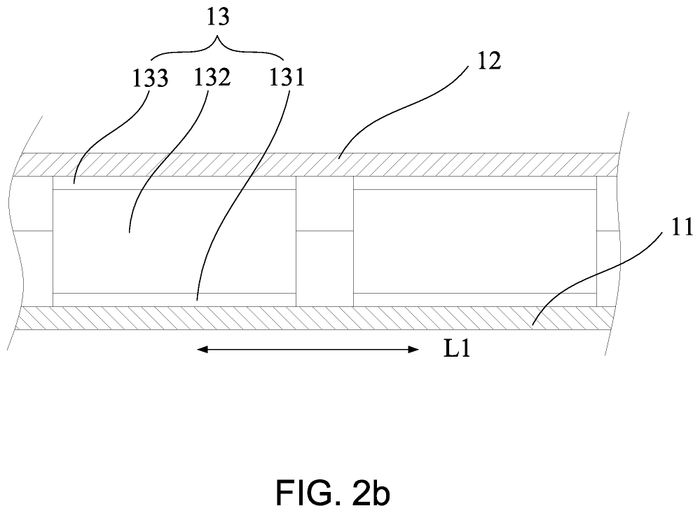

As shown in FIG. 2 and FIG. 3, in an embodiment of the disclosure, each first connecting plate 112 is provided with a plurality of nuts 30, and each first connecting plate 112 is provided with through holes (not shown) corresponding to the threaded holes of the nuts 30.

One end of a screw sequentially passes through the horizontal beam 20 and the through hole and is screwed to the nut 30, and the other end of the screw interferes with the horizontal beam 20. That is, the horizontal beam 20 is fixed to the vertical column 10 through the matching between the screw and the nut 30. The connection between the nut 30 and the screw is simple and exhibits high connection strength, such that the fixing strength between the horizontal beam 20 and the vertical column 10 is improved. Therefore, the overall strength of the energy storage rack is ensured, the service life of the product is prolonged, and the market competitiveness of the product is increased.

As shown in FIG. 6 and FIG. 7, in an embodiment of the disclosure, the second connecting plates 122 extend to the nut 30. In a specific embodiment of the disclosure, the length of each second connecting plate 122 is less than the length of each first connecting plate 112, so that each second connecting plate 122 does not interfere with the nut 30. In addition, each second connecting plate is also provided with an avoiding groove corresponding to the nut.

The extension of each second connecting plate 122 to the nut 30 leads to an increase in the thickness of the position corresponding to the first connecting plate 112, so that the nuts 30 are stably and securely fixed onto the first beam 11. As such, the fixing strength between the horizontal beam 20 and the vertical column 10 established based on the fixed connection between the screws and the nuts 30 is thereby ensured. Therefore, the overall strength of the energy storage rack is ensured, the service life of the product is prolonged, and the market competitiveness of the product is increased.

As shown in FIG. 6 and FIG. 7, in an embodiment of the disclosure, a depth D1 of the first groove 113 is 1 to 4 times a depth D2 of the second groove 123. In a specific embodiment of the disclosure, the depth D1 of the first groove 113 is the same as the depth D2 of the second groove 123.

By reasonably configuring the depth of the first groove 113 and the depth of the second groove 123, the strength of the first beam 11 and the second beam 12 is ensured. As such, the overall strength of the vertical column 10 formed by the first beam 12 and the second beam 10 is ensured, and the vertical column 10 may not be easily broken, may not be easily deformed, and exhibits good reliability in use. Therefore, the overall reliability in use of the energy storage rack is improved, the probability of damage to the energy storage rack is reduced, the service life of the product is prolonged, and the market competitiveness of the product is increased.

As shown in FIG. 2 to FIG. 5, in an embodiment of the disclosure, the first beam 11 is provided with a plurality of functional holes 40, and/or the second beam 12 is provided with a plurality of functional holes 40.

The functional holes 40 include but not limited to weight-reducing holes, copper row holes, wire-passing holes, etc. In the case of ensuring the overall strength of the column 10, the weight-reducing holes are disposed on the second beam and are located on the bottom of the second groove. The arrangement of the weight-reducing holes may reduce the weight of the vertical column 10, thereby reducing the overall weight of the energy storage rack and facilitating the transportation of the energy storage rack. The copper row holes are arranged on the first beam and are located on the side wall of the first groove, and the copper row holes are configured to allow copper rows to pass through conveniently. The wire-passing holes are arranged on the first beam and are located on the side wall of the first groove. A wire may be routed inside the vertical column 10 through the wire-passing holes, which facilitates the wiring of the wire. Further, when the inner wall of each vertical column 10 needs to be sprayed with plastic, the inner wall of the vertical column 10 may be sprayed with plastic through the functional holes 40, so that the inner wall of the vertical column 10 may be conveniently sprayed with plastic.

In the disclosure, the shape of the functional holes may be circular, oblong, oval, etc., which are not listed herein one by one. The functional holes may be placed at any position of the vertical columns according to the needs, and a person having ordinary skill in the art may select the shape and arrangement positions of the functional holes according to needs.

As shown in FIG. 3, FIG. 6, and FIG. 7, in an embodiment of the disclosure, the vertical column 10 further includes a reinforcement beam 13.

The reinforcement beam 13 is supported between the first beam 11 and the second beam 12, and the reinforcement beam 13 is fixedly connected to the first beam 11 and the second beam 12. That is, the reinforcement beam 13 is arranged in the hollow cavity of the vertical column 10.

As shown in FIG. 2 and FIG. 2a, in a specific embodiment of the disclosure, one reinforcement beam 13 is arranged in the vertical column 10, and the reinforcement beam 13 is arranged in a length direction L1 of the vertical column 10. To be specific, a length of the reinforcement beam 13 is the same as a length of the vertical column 10, so that the reinforcement beam 13 may effectively provide support for the vertical column 10. Alternatively, as shown in FIG. 2b, a plurality of reinforcement beams 13 are arranged in the vertical column 10, the plurality of reinforcement beams 13 are arranged in the length direction L1 of the vertical column 10, and the plurality of reinforcement beams 13 are arranged in the vertical column 10 at equal intervals. The overall weight of the energy storage rack may be effectively reduced while the reinforcement beam 13 may effectively support the vertical column 10.

The reinforcement beam 13 provides a supporting force for the first beam 11 and the second beam 12, so that the impact resistance capability of the vertical column 10 is improved. As such, the overall strength of the vertical column is improved, and the vertical column 10 may not be easily broken, may not be easily deformed, and exhibits good reliability in use. Therefore, the overall reliability in use of the energy storage rack is improved, the probability of damage to the energy storage rack is reduced, the service life of the product is prolonged, and the market competitiveness of the product is increased.

Several embodiments of the reinforcement beam 13 are described below with reference to the accompanying drawings.

### Embodiment One

As shown in FIG. 6, in an embodiment of the disclosure, the reinforcement beam 13 includes a first plate 131, a second plate 132, and a third plate 133 connected in sequence.

The first plate 131 and the third plate 133 are located on a same side of the second plate 132, the first plate 131 is connected to the first beam 11, and the third plate 133 is connected to the second beam 12. To be specific, the first plate 131 is connected to a bottom wall of the first groove 113, and the third plate 133 is connected to a bottom wall of the second groove 123. In a specific embodiment of the disclosure, a plate surface of the first plate 131 is attached to a bottom surface of the first groove 113, and a plate surface of the third plate 133 is attached to a bottom surface of the second groove 123.

The reinforcement beam 13 of the abovementioned structure has a “C” shape as a whole. The first plate 131 ensures the connection area between the reinforcement beam 13 and the first beam 11, and the third plate 133 ensures the connection area between the reinforcement beam 13 and the second beam 12, such that the connection strength between the reinforcement beam 13 and the first beam 11 and the second beam 12 is ensured. The second plate 132 provides a supporting force for the first beam 11 and the second beam 12, so that the reinforcement beam 13 effectively provides support for the first beam 11 and the second beam 12. As such, the impact resistance capability of the vertical column 10 is enhanced, the overall strength of the vertical column is improved, and the vertical column 10 may not be easily broken, may not be easily deformed, and exhibits good reliability in use. Therefore, the overall reliability in use of the energy storage rack is improved, the probability of damage to the energy storage rack is reduced, the service life of the product is prolonged, and the market competitiveness of the product is increased.

### Embodiment Two

As shown in FIG. 7, in an embodiment of the disclosure, the reinforcement beam 13 has a plurality of third grooves 134, and opening directions of two adjacent third grooves 134 are opposite. In a specific embodiment of the disclosure, the reinforcement beam 13 includes a plurality of vertical plates 135 and a plurality of horizontal plates 136, and the horizontal plates 136 and the vertical plates 135 are arranged in an alternating manner. Two vertical plates 135 and one horizontal plate 136 enclose one third groove 134. A part of the horizontal plates 136 are attached to the bottom surface of the first groove 113, and another part of the horizontal plates 136 are attached to the bottom surface of the second groove 123. The plurality of vertical plates 135 are supported between the first beam 11 and the second beam 12.

The reinforcement beam 13 of the abovementioned structure has a square wave shape as a whole, so that a plurality of connection surfaces are provided between the reinforcement beam 13 and the first beam 11 and the second beam 12. Therefore, the connection area between the reinforcement beam 13 and the first beam 11 and the connection area between the reinforcement beam 13 and the second beam 12 are increased, so as to ensure the connection strength between the reinforcement beam 13 and the first beam 11 and the second beam 12. In addition, multiple parts of the reinforcement beam 13 provide supporting forces for the first beam 11 and the second beam 12, so that the reinforcement beam 13 effectively supports the first beam 11 and the second beam 12. As such, the impact resistance capability of the vertical column 10 is enhanced, the overall strength of the vertical column is improved, and the vertical column 10 may not be easily broken, may not be easily deformed, and exhibits good reliability in use. Therefore, the overall reliability in use of the energy storage rack is improved, the probability of damage to the energy storage rack is reduced, the service life of the product is prolonged, and the market competitiveness of the product is increased.

A person having ordinary skill in the art should understand that, in addition to the abovementioned shapes, the reinforcement beam may also be I-shaped, Z-shaped, mouth-shaped, etc., which are not listed herein one by one.

Note that in the description of the disclosure, the terms “first”, “second”, “third”, etc. are only used for descriptive purposes and cannot be understood as indicating or implying relative importance. Note that in the description of the disclosure, unless clearly specified and defined otherwise,

Note that in the description of the disclosure, unless clearly specified and defined otherwise, the terms “mounted”, “connected”, and “connecting” should be understood in a broad sense. The term “plurality” refers to one or more than one unless specifically defined otherwise. For a person having ordinary skill in the art, the specific meaning of the abovementioned terms in the disclosure can be understood according to specific circumstances.

Other embodiments of the disclosure will be apparent to those skilled in the art from consideration of the specification and practice of the disclosure disclosed herein. The disclosure is intended to cover any variations, uses or adaptations of the disclosure. These variations, uses, or adaptations follow the general principles of the disclosure and include common general knowledge or conventional technical means in the art that are not disclosed in the present disclosure. The specification and embodiments are illustrative, and the real scope and spirit of the present disclosure is defined by the appended claims.

It should be understood that the disclosure is not limited to the precise structures that have been described above and shown in the drawings, and various modifications and variations can be made without departing from the scope thereof. The scope of the disclosure is limited only by the appended claims.

What is claimed is:

1. An energy storage rack, comprising a vertical column and a horizontal beam connected to each other, wherein:
the vertical column is a hollow column structure formed by a first beam and a second beam butting against each other;
the first beam comprises a first main body and first connecting plates, the first main body has a first groove, two sides of the first main body are respectively connected to the first connecting plates, and the first connecting plates are located at an opening of the first main body; and
the second beam comprises a second main body and second connecting plates, the second main body has a second groove, two sides of the second main body are respectively connected to the second connecting plates, the second connecting plates are located at an opening of the second main body, the two second connecting plates are correspondingly connected to the two first connecting plates, and the first groove communicates with the second groove to form a hollow cavity.

2. The energy storage rack according to claim 1, wherein the vertical column further comprises a reinforcement beam, the reinforcement beam is supported between the first beam and the second beam and is located in the hollow cavity, and the reinforcement beam is fixedly connected to the first beam and the second beam.

3. The energy storage rack according to claim 2, wherein the reinforcement beam is disposed in a length direction of the vertical column.

4. The energy storage rack according to claim 2, wherein the reinforcement beam comprises a first plate, a second plate, and a third plate connected in sequence, the first plate and the third plate are located on a same side of the second plate, the first plate is connected to the first beam, and the third plate is connected to the second beam.

5. The energy storage rack according to claim 4, wherein:
a plate surface of the first plate is attached to a bottom surface of the first groove; and
a plate surface of the third plate is attached to a bottom surface of the second groove.

6. The energy storage rack according to claim 2, wherein the reinforcement beam has a plurality of third grooves, and opening directions of adjacent two of the third grooves are opposite.

7. The energy storage rack according to claim 6, wherein the reinforcement beam comprises a plurality of vertical plates and a plurality of horizontal plates, the horizontal plates and the vertical plates are arranged in an alternating manner, two of the vertical plates and one of the horizontal plates enclose one third groove, plate surfaces of a part of the horizontal plates are attached to a bottom surface of the first groove, plate surfaces of another part of the horizontal plates are attached to a bottom surface of the second groove, and the plurality of vertical plates are supported between the first beam and the second beam.

8. The energy storage rack according to claim 1, wherein one end of each first connecting plate away from the first main body is provided with a reinforcement folded edge.

9. The energy storage rack according to claim 2, wherein one end of each first connecting plate away from the first main body is provided with a reinforcement folded edge.

10. The energy storage rack according to claim 4, wherein one end of each first connecting plate away from the first main body is provided with a reinforcement folded edge.

11. The energy storage rack according to claim 6, wherein one end of each first connecting plate away from the first main body is provided with a reinforcement folded edge.

12. The energy storage rack according to claim 1, wherein:
the first beam is a beam formed by bending a sheet metal piece; and/or
the second beam is a beam formed by bending a sheet metal piece.

13. The energy storage rack according to claim 1, wherein each first connecting plate is provided with a plurality of nuts, and each first connecting plate is provided with through holes corresponding to threaded holes of the nuts.

14. The energy storage rack according to claim 13, wherein the second connecting plates extend to the nuts.

15. The energy storage rack according to claim 1, wherein a depth of the first groove is 1 to 4 times a depth of the second groove.

16. The energy storage rack according to claim 2, wherein a depth of the first groove is 1 to 4 times a depth of the second groove.

17. The energy storage rack according to claim 4, wherein a depth of the first groove is 1 to 4 times a depth of the second groove.

18. The energy storage rack according to claim 6, wherein a depth of the first groove is 1 to 4 times a depth of the second groove.

19. The energy storage rack according to claim 6, wherein:
the first beam is provided with a plurality of functional holes; and/or
the second beam is provided with a plurality of functional holes.

20. The energy storage rack according to claim 1, wherein the horizontal beam is connected to the first connecting plates.
